(19) United States
(12) Patent Application Publication
(10) Pub. No.: US 2023/0140443 A1
(43) Pub. Date: May 4, 2023

(54) POLYACRYLAMIDE COMPOSITION AND ITS USE

(71) Applicant: KEMIRA OYJ, Helsinki (FI)

(72) Inventors: Asko KARPPI, Espoo (FI); Salla TIMPERI, Espoo (FI); Matti HIETANIEMI, Espoo (FI)

(21) Appl. No.: 17/906,358

(22) PCT Filed: Mar. 17, 2021
(86) PCT No.: PCT/FI2021/050191

§ 371 Date: Sep. 15, 2022

(30) Foreign Application Priority Data
Mar. 18, 2020 (FI) 20205274

(51) Int. Cl. C08L 33/26; C08K 5/07

(52) U.S. Cl. CPC C08L 33/26; C08K 5/07

(57) ABSTRACT

An aqueous prepolymer composition, which comprises a polyacrylamide base polymer comprising 10 - 40 mol-% of cationic monomers and having a weight average molecular weight Mw in the range of 120 000 - 350 000 g/mol, 0.1 - 1 weight-% of glyoxal, calculated from the total weight of the aqueous prepolymer composition, and a buffering acid for adjusting pH of the composition in the range of 2 - 4. A prepolymer composition is used in a method for producing on-site glyoxylated polyacrylamide useful in paper or board manufacturing.

### FIELD OF THE INVENTION

The present invention relates to a pre-mixture of polyacrylamide base polymer and glyoxal having improved storage stability and a method for producing a glyoxylated polyacrylamide from said pre-mixture as well as use of the glyoxylated polyacrylamide.

### BACKGROUND OF THE INVENTION

During papermaking process various chemicals are commonly added to enhance the physical properties of paper or board. Glyoxylated polyacrylamide (GPAM) products are polyacrylamide-based polymers crosslinked by using glyoxal, which are typically used in a variety of paper or board grades, e.g. to improve dry strength and/or wet strength. GPAM is a reactive polymer that can covalently bind with cellulose.

It is known that glyoxylated polyacrylamide compositions have challenges in their commercial use. Glyoxylated polyacrylamide composition is commonly transported and stored in a form of an aqueous solution. However, the concentration of the GPAM product is fairly low, e.g. 5 - 7 weight-%, wherein the transportation costs of GPAM compositions increase due to large volumes and/or the storage stability of the compositions may be inadequate. The GPAM compositions are not totally stable, but glyoxal still tends to continue cross-linking the polyacrylamide base polymer and thus the viscosities of the aqueous solutions tend to increase during storage and leading finally to gel-formation. Hence, the GPAM compositions have limited shelf-life and after gel-formation the compositions cannot be used anymore.

Due to the limitations in storage stability, GPAM products manufactured at paper mill just before addition to the wet end of paper making process, i.e. on-site produced GPAMs, have lately gained market. However, there is some challenges in relation to on-site manufacturing of GPAM, since glyoxal is a hazard chemical and content of 1 weight-% or more causes classification (Hazard class/Hazard statement code) of 2/H341: “Suspected of causing genetic defects” and 1/H317: “May cause an allergic skin reaction”. In general, chemicals with such classifications are not preferably accepted in all paper and board mills. In addition, application team personnel at the paper or board mill are not necessarily experienced on handling hazard chemicals. This creates a safety risk which requires proper education and decent training concerning chemistry of glyoxal and manufacturing of GPAM and safe handling of glyoxal.

A low glyoxal level GPAM product contains typically free glyoxal between 0.1 - 0.99 weight-% in which case the products are under label EUH208: “May produce an allergic reaction”. This label is mostly accepted by the paper and board mills. Hence, there is need for novel solutions for producing GPAMs on-site at paper or board mills, which are safer to use.

### SUMMARY OF THE INVENTION

It is an object of the present invention to provide a pre-mixture for producing on-site glyoxylated polyacrylamide, which pre-mixture has a good storage stability.

Further, it is an object of the present invention to provide a pre-mixture with low glyoxal content for producing GPAM on-site and hence provide safer chemical to be handled at the mill. Hence, an object of the invention is also to provide a prepolymer composition for producing on-site glyoxylated polyacrylamide which is not classified in the hazard classes of 2/H341 and 1H317.

Further, the invention provides a process for producing glyoxylated polyacrylamide composition on-site from a pre-mixture comprising a polyacrylamide base polymer and glyoxal.

In order to achieve among others the objects presented above, the invention is characterized by what is presented in the characterizing parts of the enclosed independent claims.

The embodiments and advantages mentioned in this text relate, where applicable, both to the aqueous prepolymer composition, the method as well as to the uses according to the invention, even though it is not always specifically mentioned.

A typical aqueous prepolymer composition according to the present invention comprises
a polyacrylamide base polymer comprising 10 - 40 mol-% of cationic monomers and having a weight average molecular weight Mw in the range of 120 000 - 350 000 g/mol,
0.1 1 weight-% of glyoxal, calculated from the total weight of the aqueous prepolymer composition, and
a buffering acid,
wherein the pH of the aqueous prepolymer composition is in the range of 2 -4 and a solid content of the aqueous prepolymer composition is 5 - 25 weight-%.

A typical method according to the invention for producing a glyoxylated polyacrylamide useful in paper or board manufacturing, wherein the method comprises
obtaining an aqueous prepolymer composition according to the present invention, which comprises
   a polyacrylamide base polymer comprising 10 - 40 mol-% of cationic monomers and having a weight average molecular weight Mw in the range of 120 000 - 350 000 g/mol,
   0.1 1 weight-% of glyoxal, calculated from the total weight of the aqueous prepolymer composition, and
   a buffering acid, and
   which aqueous prepolymer composition has the pH in the range of 2 -4 and a solid content of 5 - 25 weight-%.
adding base to said aqueous prepolymer composition to adjust the pH of the aqueous prepolymer composition to a value from 7.5 to 10, and
allowing the glyoxal and the polyacrylamide base polymer contained in said aqueous prepolymer composition to react and form glyoxylated polyacrylamide compostion.

A typical glyoxylated polyacrylamide according to the present invention is manufactured by the method according to the present invention. Especially, a glyoxylated polyacrylamide is manufactured on-site at paper or board mill from an aqueous prepolymer composition according to the present invention.

A glyoxylated polyacrylamide according to the present invention is typically used in manufacturing of paper or board as a dry strength agent and/or a dewatering agent.

The present invention is based on a pre-mixture, i.e. an aqueous prepolymer composition comprising a polyacrylamide base polymer with high enough cationicity and high enough weight average molecular weight (Mw) and unreacted glyoxal in the range between 0.1 - 1 weight-%, preferably below classification limit of 1 weight-%, for using in manufacturing of GPAM on-site at paper or board mill. It has been observed that a prepolymer composition according to the present invention, which have storage stability at 25° C. more than30 days and which is applicable as a dry strength and/or dewatering agent for paper or board after on-site processing, can be successfully made. When the polyacrylamide base polymer contains high enough cationicity and having high enough weight average molecular weight (Mw), then required glyoxal level can be set to a such low level that it is in the range of 0.1 - 1 weight-%, preferably below 1 weight-% at solid content of 5 - 25 weight-%, preferably at 10 - 20 weight-% or 10 - 18 weight-%. The high Mw of the polyacrylamide base polymer requires less crosslinking with glyoxal to achieve sufficient molecular size for dry strength and/or dewatering application. Whereas high enough cationicity of the polyacrylamide base polymer impacts beneficially on storage stability. The phenomenon is maybe due to electrostatic repulsion of cationic groups, i.e. cationic groups prevents polymer chains to get close enough to make a crosslink. An aqueous prepolymer composition according to the present invention is safe to handle at site since it does not contain glyoxal above the classification limit of 1 weight-% and a glyoxylated polyacrylamide manufactured from said prepolymer composition is applicable as a dry strength and/or dewatering agent for paper or board.

### DETAILED DESCRIPTION OF THE INVENTION

An aqueous prepolymer composition according to the present invention comprises
polyacrylamide base polymer comprising 10 - 40 mol-% of cationic monomers and having a weight average molecular weight Mw in the range of 120 000 - 350 000 g/mol, and
0.1 - 1 weight-% of glyoxal, calculated from the total weight of the aqueous prepolymer composition.

An aqueous prepolymer composition according to the present invention is a pre-mixture which comprises polyacrylamide base polymer, unreacted glyoxal and water. An aqueous prepolymer composition according to the present invention is stable at acidic conditions. Typically, the pH of the prepolymer composition is in the range of 2 - 4, preferably 2.2 - 3.5 and more preferably 2.5 - 3.3. If the pH of the aqueous prepolymer composition is higher than 4, there is a risk for gel-formation. At paper or board mill the crosslinking reaction of the components of the prepolymer composition according to the present invention can be reactivated by adjusting the solution to alkaline pH conditions.

When a polyacrylamide base polymer contains high enough cationicity and having high enough weight average molecular weight (Mw), then required glyoxal level can be set to a such low level that it is in the range of 0.1 - 1 weight-%, preferably below 1 weight-% at solid content of 5 - 25 weight-%, preferably at 10 - 20 weight-% or 10 - 18 weight-% for achieving a stable pre-mixture. According to an embodiment of the present invention, an aqueous prepolymer composition comprises 0.1 - 1 weight-%, preferably 0.2 - 1 weight-%, more preferably 0.1 - 0.99 or 0.1 - 0.95 weight-%, and even more preferably 0.2 - 0.99 or 0.2 - 0.95 weight-% of glyoxal, calculated from the total weight of the aqueous prepolymer composition. In a preferred embodiment according to the present invention, glyoxal content is below 1 weight-% wherein it is below classification limit (Hazard class/Hazard statement code) of 2/H341 and provides more safety use of the prepolymer composition at paper or board mill.

According to an embodiment of the present invention, a solid content of the aqueous prepolymer composition is 5 - 25 weight-%, preferably 8 - 25 weight-% or 8 - 20 weight-% and more preferably 10 - 20 weight-% or 10 -18 weight-%. A feasible solid content is dependent on the Mw of polyacrylamide base polymer.

According to the present invention, a polyacrylamide base polymer of the aqueous prepolymer composition has a weight average molecular weight Mw in the range of 120 000 - 350 000 g/mol. In an embodiment according to the present invention, the weight average molecular weight Mw of the polyacrylamide base polymer is in the range of 120 000 - 300 000 g/mol, preferably 120 000 - 250 000 g/mol or 120 000 - 200 000 g/mol. The high Mw of the polyacrylamide base polymer requires less crosslinking with glyoxal to achieve sufficient molecular size for use as dry strength and/or dewatering agent, especially in manufacturing paper or board comprising recycled fibres. Hence, a prepolymer composition according to an embodiment of the present invention can comprise below classification limit of 1 weight-% unreacted glyoxal, i.e. free glyoxal, calculated from the total weight of the composition, since it is enough for crosslinking purposes for obtaining suitable glyoxylated polyacrylamide to be used in dry strength and/or dewatering purposes.

According to the present invention, a polyacrylamide base polymer of the aqueous prepolymer composition comprising 10 - 40 mol-% of cationic monomers for providing adequate solution stability for the aqueous prepolymer composition. Storage stability of the GPAM composition according to the invention is improved with high amount of cationic monomers, but high amount of cationic monomers may decrease strength response of paper with furnishes which contain low zeta-potential value. The amount of cationic monomers can be selected to obtain desired binding of the polymer to the fibres in the stock and thus the dry strength effect. In an embodiment according to the present invention, a polyacrylamide base polymer comprises 10 - 35 mol-% and more preferably 10 - 25 mol-%, of cationic monomers.

According to the present invention, an amount of cationic monomers and weight average molecular weight (Mw) of a polyacrylamide base polymer can be varied in the ranges presented above, wherein the polyacrylamide base polymer with high enough cationicity in combination with high enough weight average molecular weight (Mw) is achieved and premixed with unreacted glyoxal in the range between 0.1 - 1 weight-%, preferably below classification limit of 1 weight-% (calculated from the total weight of the composition) for using in manufacturing of GPAM on-site at paper or board mill.

According to an embodiment of the present invention, a polyacrylamide base polymer comprises (meth)acrylamide and cationic monomers selected from diallyldimethylammonium chloride (DADMAC), 3-(acrylamidopropyl)trimethylammonium chloride (APTAC), 3-(methacrylamidopropyl)trimethyl-ammonium chloride (MAPTAC) and any combinations thereof. These cationic monomers have hydrolytic stability which improves the stability of the prepolymer composition according to the invention. In a preferred embodiment according to the present invention, the polyacrylamide base polymer comprises (meth)acrylamide and diallyldimethylammonium chloride (DADMAC). The cationic polyacrylamide base polymer may comprise only one type of cationic monomers, or it may comprise combination of two or more different cationic monomers.

According to the present invention, an aqueous prepolymer composition comprises further a buffering acid. Typically, the pH of the prepolymer composition is adjusted in the range of 2 - 4, preferably 2.2 - 3.5 and more preferably 2.5 - 3.3. If the pH of the aqueous prepolymer composition is higher than 4, there is a risk for gel-formation. If pH is lower than 2.2, then the risk of amide group hydrolysis increases. If pH is higher than 3.5, and especially higher than 4 then storage stability of the prepolymer composition may be inadequate. Typically, a buffering acid is an aqueous solution comprising an organic acid and/or salt thereof. According to one embodiment of the invention, the buffering acid solution comprises formic acid or citric acid, or any salt thereof, like sodium formiate or sodium citrate. In an embodiment according to the present invention, the buffering acid comprises formic acid.

An aqueous prepolymer composition according to an embodiment of the present invention has a viscosity of less than 150 mPas measured at 25° C. by using Brookfield viscometer, after stored 30 days at 25° C., and/or an increase of Brookfield viscosity, measured at 25° C., is less than 100 % after stored 30 days at 25° C. Hence, an aqueous prepolymer composition according to the present invention has a good storage stability.

At paper or board mill the crosslinking reaction of the components of the aqueous prepolymer composition according to the present invention can be reactivated by adjusting the solution to alkaline pH conditions. A method according to the present invention for producing a glyoxylated polyacrylamide useful in paper or board manufacturing compries
obtaining an aqueous prepolymer composition according to the present invention,
adding base to said aqueous prepolymer composition to adjust the pH of the prepolymer composition to a value from 7.5 to 10, preferably from 8 to 10 or about 9, and
allowing the glyoxal and the polyacrylamide base polymer contained in said aqueous prepolymer composition to react and form glyoxylated polyacrylamide composition.

An aqueous prepolymer composition according to the present invention is at acidic conditions. Typically, the pH of the prepolymer composition is in the range of 2 - 4, preferably 2.2 - 3.5 and more preferably 2.5 - 3.3. At paper or board mill the crosslinking reaction of the components of the aqueous prepolymer composition according to the present invention can be reactivated by adjusting the solution to alkaline pH conditions, typically to a pH value from 7.5 to 10, preferably from 8 to 10 or about 9. In an embodiment of the present invention, the reaction between the glyoxal and the polyacrylamide base polymer is continued until viscosity is 2 - 10 times, preferably 2- 5 times greater than the Brookfield viscosity of the reaction mixture at the beginning, whereafter the reaction is stopped by lowering the pH below 7.5.

Once reaching a final viscosity range, the obtained glyoxylated polyacrylamide composition can be applied to the paper or board machine with or without further dilution by water. According to an embodiment of the present invention, a method for producing a glyoxylated polyacrylamide from an aqueous prepolymer composition comprises a further step, wherein the formed glyoxylated polyacrylamide composition is further diluted by addition of water. According to an embodiment of the present invention, a solid content of the formed glyoxylated polyacrylamide composition is adjusted to 3-7 weight-% in on-site manufacturing process.

A glyoxylated polyacrylamide produced on-site at paper or board mill from an aqueous prepolymer composition according to the present invention is typically used immediately, or at least during next 1 - 3 days after on-site manufacturing, wherein storage stability of the glyoxylated polyacrylamide is not a critical property and does not cause problems. The obtained glyoxylated polyacrylamide can be applied to the paper or board machine directly with or without further dilution.

A glyoxylated polyacrylamide according to the present invention is commonly used in manufacturing of paper or board as a dry strength agent and/or dewatering agent. In a preferred embodiment of the present invention, the glyoxylated polyacrylamide is used as a dry strength agent and/or dewatering agent in manufacturing of paper or board comprising recycled fibres. The crosslinking of the polyacrylamide base polymer enables higher dosage amount of polymer with high Mw without over-flocculation and hence the glyoxylated polyacrylamide produced from the prepolymer composition according to the present invention is suitable for dry strength and/or dewatering applications. In addition, recycled fibre material comprises typically huge amounts of fillers, wherein the glyoxylated polyacrylamide according to the present invention with high Mw is applicable for strength purposes.

According to an embodiment of the present invention a method for increasing the dry strength properties and/or dewatering of paper or board comprises
obtaining a fibre stock,
adding a glyoxylated polyacrylamide according to the present invention to the fibre stock, and
forming the fibre stock into paper, board or the like.

A glyoxylated polyacrylamide according to the present invention is manufactured on-site and it may be added to the fibre stock at any suitable location, for example at any suitable wet end location, to produce a paper or board with increased strength. A fibre stock may also be called pulp slurry or pulp suspension. An aqueous glyoxylated polyacrylamide polymer composition according to the present invention may be added to the papermaking process at any point where such strength and/or dewatering additives are generally added. A glyoxylated polyacrylamide polymer composition may be added at any time before the paper web is formed. An addition of the glyoxylated polyacrylamide polymer composition can be made to thick stock or thin stock.

### EXPERIMENTAL PART

### Example 1. Pre-mixtures of High Cationic GPAM With Low Glyoxal Content

A series of high cationic glyoxylated polyacrylamide (GPAM) pre-mixtures, i.e. aqueous pre-polymer compositions, were made by mixing a high cationic polyacrylamide base polymer, water, formic acid (HCOOH) and glyoxal. Characteristics of the pre-mixtures are showed at Table 1. Glyoxal content is not determined value, but calculated value with the assumption that 0% has been reacted.

A high cationic polyacrylamide base polymer was copolymer of polyacrylamide (77 mol-%) and diallyldimethylammonium chloride (DADMAC) (23 mol-%), polymerized by radical polymerization. A weight average molecular weight, Mw of the base polymer was 123 000 g/mol.

TABLE 1

Characteristics of the GPAM pre-mixtures

| Substance/ Characteristic | Pre-mixture 1 | Pre-mixture 2 | Pre-mixture 3 | Pre-mixture 4 |
|---|---|---|---|---|
| Base polymer (34%), g | 24.3 | 18.2 | 24.6 | 18.5 |
| Water, g | 18.0 | 24.5 | 17.9 | 24.3 |
| HCOOH (85%), g | 0.47 | 0.47 | 0.47 | 0.47 |
| Glyoxal (40%), g | 1.46 | 1.10 | 1.09 | 0.82 |
| Dry content, w% | 20 | 15 | 20 | 15 |
| Glyoxal content, weight-% of the mixture | 1.32 | 0.99 | 0.99 | 0.75 |
| Viscosity, cP | 155 | 61.5 | 156 | 64 |
| pH | 2.56 | 2.47 | 2.55 | 2.48 |

The GPAM pre-mixtures were stored at 23° C. and at 35° C. Viscosities were determined at 25° C. by Brookfield DV1+ viscometer, equipped with small sample adapter, with spindle S18, using maximum feasible rotation speed. Results of storage stability tests of the pre-mixtures are showed at Tables 2 and 3.

TABLE 2

Storage stability at +23° C. (room temperature).

| Storage time | Pre-mixture 1 | Pre-mixture 2 | Pre-mixture 3 | Pre-mixture 4 |
|---|---|---|---|---|
| Days | Viscosity, mPas | Viscosity, mPas | Viscosity, mPas | Viscosity, mPas |
| 0 | 155 | 61.5 | 156 | 64 |
| 32 | 173 | 68.5 | 179 | 71.5 |
| 132 | - | 231 | - | 161 |

TABLE 3

Storage stability at +35° C.

| Storage time | Pre-mixture 1 | Pre-mixture 2 | Pre-mixture 3 | Pre-mixture 4 |
|---|---|---|---|---|
| Days | Viscosity, mPas | Viscosity, mPas | Viscosity, mPas | Viscosity, mPas |
| 0 | 155 | 61.5 | 156 | 64 |
| 5 | 164 | 62.5 | 167 | 65.0 |
| 13 | 283 | 75.8 | 287 | 76.5 |

Pre-mixtures of high cationic GPAM with low free glyoxal level (below 2 weight-%) are stable 2 weeks at 35° C. at dry content of 15 %. Stability at room temperature (23° C.) was observed to be over 4 months.

### Example 2. Pre-Mixtures of Medium Cationic GPAM With Low Glyoxal Content

A series of medium cationic glyoxylated polyacrylamide (GPAM) pre-mixtures were made in a similar way as in the Example 1. Characteristics of the pre-mixtures are showed at Table 4. Glyoxal content is calculated value with the assumption that 0% has been reacted.

A medium cationic polyacrylamide base polymer was copolymer of polyacrylamide (87 mol-%) and diallyldimethylammonium chloride (DADMAC) (13 mol-%), polymerized by radical polymerization. A weight average molecular weight, Mw of the base polymer was 185 000 g/mol.

TABLE 4

Characteristics of the pre-mixtures

| Substance/Characteristic | Pre-mixture 5 | Pre-mixture 6 |
|---|---|---|
| Base polymer (30,0%), g | 106.0 | 122.0 |
| Water, g | 154.5 | 135.0 |
| Glyoxal (40%), g | 6.6 | 6.5 |
| HCOOH (85%), g | 0.48 | 0.50 |
| Dry content, w% | 13.0 | 15.0 |
| Viscosity at 25° C., cP | 111 | 178.0 |
| pH | 2.8 | 2.8 |
| Glyoxal content, weigh-% of the mixture | 0.99 | 0.98 |

The medium cationic GPAM pre-mixtures were stored at 23° C. and viscosities were determined in the same manner as in Example 1. Results of storage stability test of the pre-mixtures are showed at Table 5.

TABLE 5

Storage stability at +23° C. (room temperature).

| Storage time | Pre-mixture 5 | Pre-mixture 6 |
|---|---|---|
| Days | Viscosity, mPas | Viscosity, mPas |
| 0 | 111 | 178 |
| 7 | 111 | 179 |
| 14 | 112 | 183 |
| 44 | 119 | 209 |
| 60 | 124 | 225 |

Pre-mixtures of medium cationic GPAM with free glyoxal below 1 weight-% are stable over 60 days at room temperature (23° C.).

### Example 3. Application Test: Effect of On-Site Glyoxylated Polyacrylamide Produced from Pre-Mixture to SCT, Burst Strength and CMT30

In the present Example, the effect of addition of on-site glyoxylated polyacrylamide produced from pre-mixture (an aqueous prepolymer composition) according to the present invention was tested on SCT (short span compression strength), burst strength and crushing resistance (Corrugating Medium Test (CMT30).

GPAM products in the present application test were reacted Pre-mixture 2 from the Example 1, reacted Pre-mixture 5 from the Example 2 and a reference GPAM, which was commercial plant manufactured GPAM. Pre-mixtures were made by adding 100 g pre-mixture and 235 g de-ionized water. Temperatures of GPAM pre-mixture and de-ionized water were 23° C. (room temperature). pH was adjusted to 9.0 by aqueous sodium hydroxide solution, 10 wt-%. Start viscosity was 8 cP. The mixture was agitated by 300 rpm until viscosity increased to 32 cP, then the mixture was acidified by sulfuric acid (30 wt-%) to pH 3.0. Characteristics of GPAMs made of pre-mixtures and the commercial GPAM reference are showed in the Table 6.

TABLE 6

Characteristics of GPAM products in the application test.

| GPAM product/ characteristics | Test GPAM1 of the Pre-mixture 2 | Test GPAM2 of the pre-mixture 5 | Commercial GPAM Reference |
|---|---|---|---|
| Mw weight average of the base polymer, g/mol | 123 000 | 185 000 | 10 000 |
| DADMAC proportion of the base polymer, mol-% | 23 | 13 | 23 |
| Acrylamide proportion of the base polymer, mol-% | 77 | 87 | 77 |
| Concentration of the GPAM product, wt-% | 4.5 | 3.7 | 12.0 |
| Viscosity of GPAM at 25° C., cP | 30 | 31 | 30 |
| pH of GPAM product | 3.0 | 3.0 | 3.0 |

Tested furnish was prepared from European recycled board (RCF). 110 g/m² sheets were formed with Rapid Koethen sheet former (RK) as follows: RCF was wet disintegrated in 3% consistency at 70° C. with Noviprofibre -pulper for 30 sec at 500 rpm and 25 min at 1000 rpm at laboratory pulper without soaking. Wet disintegrated pulp was further diluted to 0.6% with tap water and pH and conductivity adjusted to 6.8 and 3.0 mS/cm. Conductivity was adjusted with salt mixture of 70% calcium acetate, 20% sodium sulfate and 10% sodium bicarbonate. Chemical additions were made to dynamic drainage jar type of mixing vessel (mixing speed 1000 rpm) and after chemical additions pulp was poured to RK sheet former and water was drained out through wire with suction. Sheet was removed from wire and dried with vacuum dryer (93° C., 10 min). Before testing in the laboratory, sheets were pre-conditioned for 24 h at 23° C. in 50 % relative humidity, according to the standard ISO 187.

GPAM products were used as a strength additive. Dosage amounts was 2.5 kg/t as dry additive per ton dry OCC fibre stock. Medium cationic GPAM was dosage also 4 kg/t as dry additive per ton dry OCC fibre stock.

All points included retention aids (CPAM FennoPol K 3500P of Kemira Oyj dissolved to 0.5% and further diluted to 0.05% concentration dosed 15 s before drainage 100 g/t as dry and Silica FennoSil 2180 of Kemira Oyj diluted to 0.1% concentration dosed 10 s before drainage 400 g/t as dry).

TABLE 7

Sheet testing devices and standard methods used for produced paper sheets.

| | | |
|---|---|---|
| Measurement | Device | Standard |
| Basis weight | Mettler Toledo | ISO 536 |
| Short Span Compression test (SCT) | Lorentzen & Wettre | ISO 9895 |
| Burst strength | Lorentzen & Wettre | ISO 2758 |
| Corrugating Medium Test (CMT30) | Lorentzen & Wettre | ISO 7263 |

Results are showed in the following Table 8. On-site GPAM produced from pre-mixtures according to the present invention improve strength properties compared to commercial GPAM reference. The improvement in all strength results is also shown in medium cationic GPAMs, when the dosage is increased.

TABLE 8

The effect of different strength systems on board properties.

| | SCT index [Nm/g] | Burst index [kPam²/g] | CMT30 [Nm²/g] | Ash, % |
|---|---|---|---|---|
| No strength additives | 21.34 | 2.10 | 0.92 | 15.2 |
| Commercial GPAM reference, 2.5 kg/t | 23.57 | 2.66 | 1.07 | 13.9 |
| Test GPAM1 of Pre-mixture 2, 2.5 kg/t | 24.26 | 2.78 | 1.08 | 14.0 |
| Test GPAM2 of Pre-mixture 5, 2.5 kg/t | 23.78 | 2.5 | 0.98 | 15.4 |
| Test GPAM2 of Pre-mixture 5, 4 kg/t | 24.74 | 2.72 | 1.1 | 14.8 |

### Example 4. Application Test: Effect of On-site Glyoxylated Polyacrylamide Produced from Pre-Mixture to Burst Strength and RCT

In the present Example, the same GPAM products were used as in the Example 3. The effect of GPAM products were tested on burst strength and crushing resistance (Ring Crush Tester (RCT).

Tested furnish was prepared from Chinese Old Corrugated Container board (OCC). 110 g/m² sheets were formed with Rapid Koethen sheet former (RK) as follows: Recycled board was wet disintegrated in 3% consistency at 70° C. for 30 sec at 500 rpm and 25 min at 1000 rpm at laboratory pulper without soaking. Wet disintegrated pulp was further diluted to 1% with tap water and pH and conductivity adjusted to 7 and 3.0 mS/cm. Conductivity was adjusted with salt mixture of 70% calcium acetate, 20% sodium sulfate and 10% sodium bicarbonate. Chemical additions were made to dynamic drainage jar type of mixing vessel (mixing speed 1000 rpm) and after chemical additions pulp was poured to RK sheet former and water was drained out through wire with suction. Sheet was removed and dried with vacuum dryer (93° C., 10 min). Before testing in the laboratory, sheets were pre-conditioned for 24 h at 23° C. in 50 % relative humidity, according to the standard ISO 187.

GPAM products were used as a strength additive. The amounts were 1.5 kg/t and 2.0 kg/t as dry additive per ton dry OCC fibre stock.

All test points included retention aid (CPAM FennoPol K 3500P of Kemira Oyj dissolved to 0.5% and further diluted to 0.05% concentration dosed 10 s before drainage 300 g/t as dry).

TABLE 9

Sheet testing devices and standard methods used for produced paper sheets.

| | | |
|---|---|---|
| Measurement | Device | Standard |
| Basis weight | Mettler Toledo | ISO 536 |
| Ring Crush Test (RCT) | Lorentzen & Wettre | Tappi T 822 om-02 |
| Burst strength | Lorentzen & Wettre | ISO 2758 |

Results are showed at Table 10. On-site GPAM produced from premixture increased substantially all the strength properties compared to commercial GPAM reference.

TABLE 10

The effect of different strength systems on board properties.

| | RCT index [Nm/g] | Burst index [kPam²/g] |
|---|---|---|
| No strength additives | 6.73 | 0.72 |
| Commercial GPAM reference, 1.5 kg/t | 7.14 | 0.81 |
| Commercial GPAM reference, 2 kg/t | 7.17 | 0.85 |
| Test GPAM1 of Pre-mixture 2, 1.5 kg/t | 7.19 | 0.84 |
| Test GPAM1 of Pre-mixture 2, 2 kg/t | 7.54 | 0.90 |

1. An aqueous prepolymer composition, which comprises
a polyacrylamide base polymer comprising 10 - 40 mol-% of cationic monomers and having a weight average molecular weight Mw in the range of 120 000 - 350 000 g/mol
0.1 - 1 weight-% of glyoxal, calculated from the total weight of the aqueous prepolymer composition; and
a buffering acid
whereinpH of the aqueous prepolymer composition is ina range of 2 - 4 and a solid content of the aqueous prepolymer composition is 5 - 25 weight-%.

2. The aqueous prepolymer composition according to claim 1, wherein the composition comprises 0.1 - 0.99 weight-% and preferably 0.2 - 0.99 weight-% of glyoxal, calculated from the total weight of the aqueous prepolymer composition.

3. The aqueous prepolymer composition according to claim 1, wherein a solid content of the composition is 8 - 20 weight-% and preferably 10 - 20 weight-% or 10 - 18 weight-%.

4. The aqueous prepolymer composition according to claim 1, wherein the weight average molecular weight Mw of the polyacrylamide base polymer is in the a range of 120 000 - 300 000 g/mol, preferably 120 000 -250 000 g/mol or 120 000 - 200 000 g/mol.

5. The aqueous prepolymer composition according to claim 1, wherein the polyacrylamide base polymer comprises 10 -35 mol-%, preferably 10 - 25 mol-%, of cationic monomers.

6. The aqueous prepolymer composition according to claim 1, wherein the polyacrylamide base polymer comprises (meth)acrylamide and cationic monomers selected from diallyldimethylammonium chloride (DADMAC), 3-(acrylamidopropyl)trimethyl-ammonium chloride (APTAC), 3-(methacrylamidopropyl)trimethyl-ammonium chloride (MAPTAC) and combinations thereof.

7. The aqueous prepolymer composition according claim 1, wherein the pH of the composition is in the range of 2.2 -3.5 and preferably 2.5 - 3.3.

8. The aqueous prepolymer composition according to claim 1, wherein the buffering acid comprises an organic acid and/or salt thereof, preferably the buffering acid comprises formic acid or citric acid, or any salt thereof, and more preferably the buffering acid comprises formic acid.

9. The aqueous prepolymer composition according to claim 1, wherein
the composition has a viscosity of less than 150 mPas, measured at 25° C. by using Brookfield viscometer, after stored 30 days at 25° C.; and/or
an increase of Brookfield viscosity, measured at 25° C., is less than 100 % after stored 30 days at 25° C.

10. A method for producing a glyoxylated polyacrylamide useful in paper or board manufacturing, wherein the method comprises
obtaining an aqueous prepolymer composition according to claim 1;
adding base to said aqueous prepolymer composition to adjust the pH of the aqueous prepolymer composition to a value from 7.5 to 10; and
allowing the glyoxal and the polyacrylamide base polymer contained in said aqueous prepolymer composition to react and form glyoxylated polyacrylamide composition.

11. The method according to claim 10,wherein the solid content of the formed glyoxylated polyacrylamide composition is adjusted to 3 - 7 weight- %.

12. The method according to claim 10, wherein the reaction between the glyoxal and the polyacrylamide base polymer is continued until viscosity is 2 - 10 times, preferably 2- 5 times greater than the Brookfield viscosity of the reaction mixture at the beginning, whereafter the reaction is stopped by lowering the pH below 7.5.

13. A glyoxylated polyacrylamide manufactured by the method according to claim 10.

14. A method to manufacture paper or board, wherein the method comprises adding the glyoxylated polyacrylamide according to claim 13 during a manufacturing processas a dry strength and/or dewatering agent.

15. The method of claim 14, wherein the in manufacturing process is manufacturing paper or board comprising recycled fibres.
